(19) United States
(12) Patent Application Publication
(10) Pub. No.: US 2007/0245556 A1
(43) Pub. Date: Oct. 25, 2007

(54) A METHOD AND SYSTEM FOR PLATED THRU HOLE PLACEMENT IN A SUBSTRATE

(76) Inventors: Eiichi Hosomi, Asao-ku (JP); Kazushige Kawaski, Shiga (JP)

Correspondence Address: IBM CORP. (WIP);c/o WALDER INTELLECTUAL PROPERTY LAW, P.C., P.O. BOX 832745, RICHARDSON, TX, 75083, US

(21) Appl. No.: 11/379,311

(22) Filed: Apr. 19, 2006

(51) Int. Cl. H01K 3/10

(52) U.S. Cl. 29/852; 29/830; 29/846; 29/847; 174/255; 257/738; 257/690

(57) ABSTRACT

A method, system, and computer program product for the layout of ground and power Plated Thru Holes (PTH) in a substrate. The PTHs can be used in a defined pattern depending upon whether anisotropy is a concern, and placed at the apex of an equilateral triangle in various arrangements.

### BACKGROUND

1. Technical Field of the Present Invention

The present invention generally relates to semiconductors, and more specifically, to methods, systems, and computer program products that assist in the placement of plated thru holes in substrates.

2. Description of Related Art

The insatiable appetite of the consumer for electronic devices that are increasingly smaller, faster, and contain more functionality than previous models has fueled the evolution of the electronic industry. Each one of these electronic devices contains one or more integrated circuits that range in complexity from a system on a chip to one or more dedicated processors.

Semiconductor packaging technology has continued to evolve in order to meet the various technical requirements dictated by these electronic devices. More specifically, the packaging technology has evolved from peripherally bonded designs to area array flip-chip configurations.

One particular structure that has become increasingly prominent is the low inductance organic package having high density Plated Thru Hole (PTH) placement. In general, PTH provides connections from the front side and back side of the organic package.

The PTH placement typically involves alternating rows of power and ground so as to assist in the reduction of the overall inductance of the integrated circuit package. Unfortunately, current methods for such placement result in high plane resistance and degradation of the power supply.

It would, therefore, be a distinct advantage to have a method and system for PTH placement that would assist in reducing the overall inductance of the integrated circuit package while keeping substrate resistance at a desirable level without substantially degrading the power supply.

### SUMMARY OF THE PRESENT INVENTION

In one aspect, the present invention is a method for creating a semiconductor package with plated place through holes. The method includes placing a first plated through hole on a first apex of a first equilateral triangle. The method also includes placing a second plated through hole on a second apex of the first equilateral triangle. In addition, the method includes placing a third plated through hole on a third apex of the first equilateral triangle.

### BRIEF DESCRIPTION OF THE DRAWINGS

The present invention will be better understood and its numerous advantages will become more apparent to those skilled in the art by reference to the following drawings, in conjunction with the accompanying specification, in which:

FIG. 1 is a diagram illustrating a layout for ground and power PTHs on a back end package;

FIG. 2 is a diagram illustrating the arrangement for ground and power PTHs on the back end package of FIG. 1 transposed on a grid;

FIG. 3 is a diagram illustrating a layout for ground and power PTHs residing on a package in accordance with a preferred embodiment of the present invention;

FIG. 4 is a diagram illustrating the placement of PTHs at the apex of an equilateral triangle according to an alternate preferred embodiment of the present invention;

FIG. 5 is a diagram illustrating the placement of PTHs using equilateral triangles as explained in connection with FIG. 4;

FIG. 6 is a diagram illustrating the placement of PTHs using equilateral triangles as explained in connection with FIG. 4;

FIG. 7 is a diagram illustrating the placement of PTHs using equilateral triangles as explained in connection with FIG. 4;

FIG. 8 is a flow chart illustrating the method for placing PTHs on an apex of an equilateral triangle as shown in FIGS. 4-7 according to an alternative preferred embodiment of the present invention; and

FIG. 9 is a block diagram is shown illustrating a computer system that implements the preferred embodiments of the present invention.

### DETAILED DESCRIPTION OF THE PREFERRED EMBODIMENT OF THE PRESENT INVENTION

The present invention is a method, system, and computer program product for the layout of ground and power Plated Thru Holes (PTH) in a substrate. In a preferred embodiment of the present invention, a limited number of alternating ground and power PTHs are used in a defined pattern depending upon whether anisotropy is a concern. In another preferred embodiment of the present invention, the power and ground PTHs are placed at the apex of an equilateral triangle in various arrangements as discussed below.

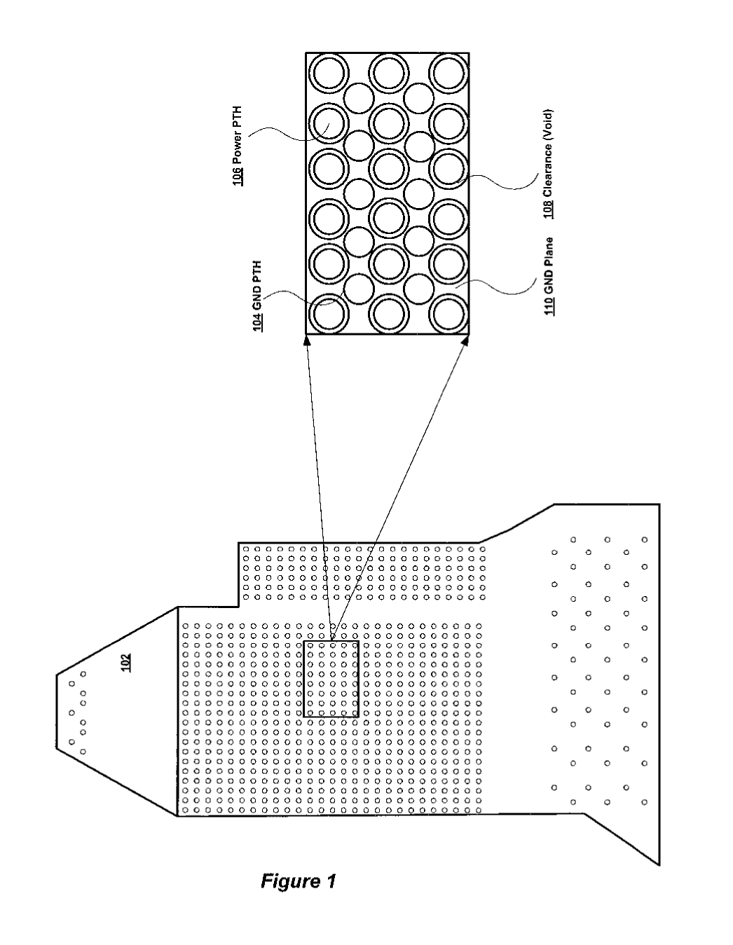

Reference now being made to FIG. 1, a diagram is shown illustrating a layout for ground and power PTHs on a back end package 102. The back end package 102 includes both power 106 and ground 104 PTHs arranged as shown. Each power PTH 106 requires a clearance (void) 108 to maintain separation from the ground plane 110. It should be noted that the power PTHs 106 are arranged such that when viewed from a horizontal perspective each row alternates between power PTHs 106 and ground PTHs 104. If viewed from a vertical perspective the power and ground PTHs 106 and 104, respectively form alternating columns.

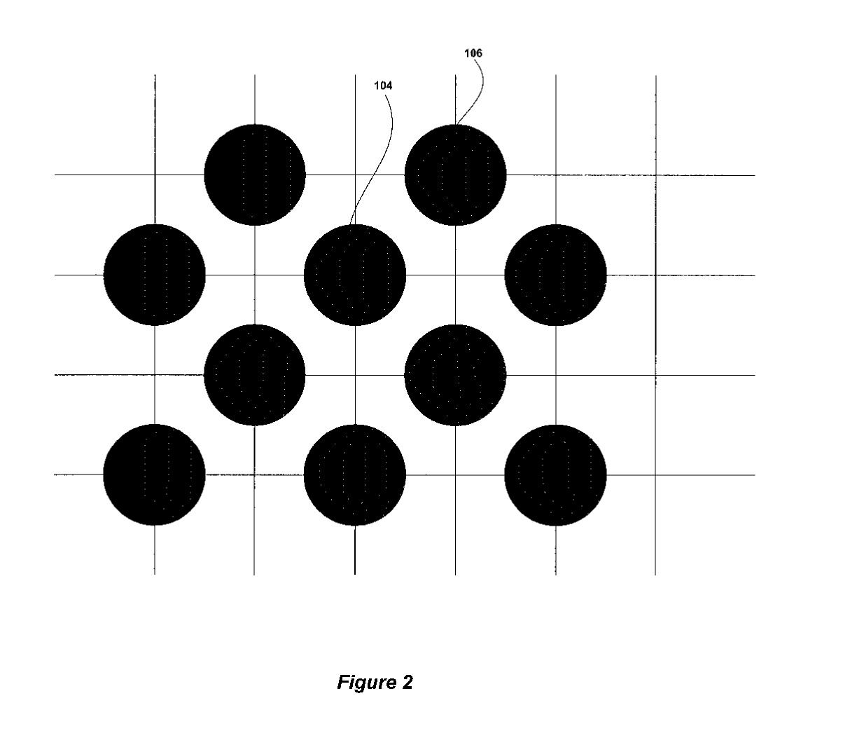

Reference now being made to FIG. 2, a diagram is shown illustrating the arrangement for ground and power PTHs on the back end package 102 transposed on a grid. The grid illustrates that each of the PTHs 104 and 106 reside on the apex of a square.

The use of this type of layout for high-density PTH placement results in undesirable characteristics such as higher plane resistance and degradation of the Direct Current (DC) power supply. The present invention provides the capability for high-density placement while reducing the undesirable characteristics from the layout previously described in connection with FIGS. 1 and 2.

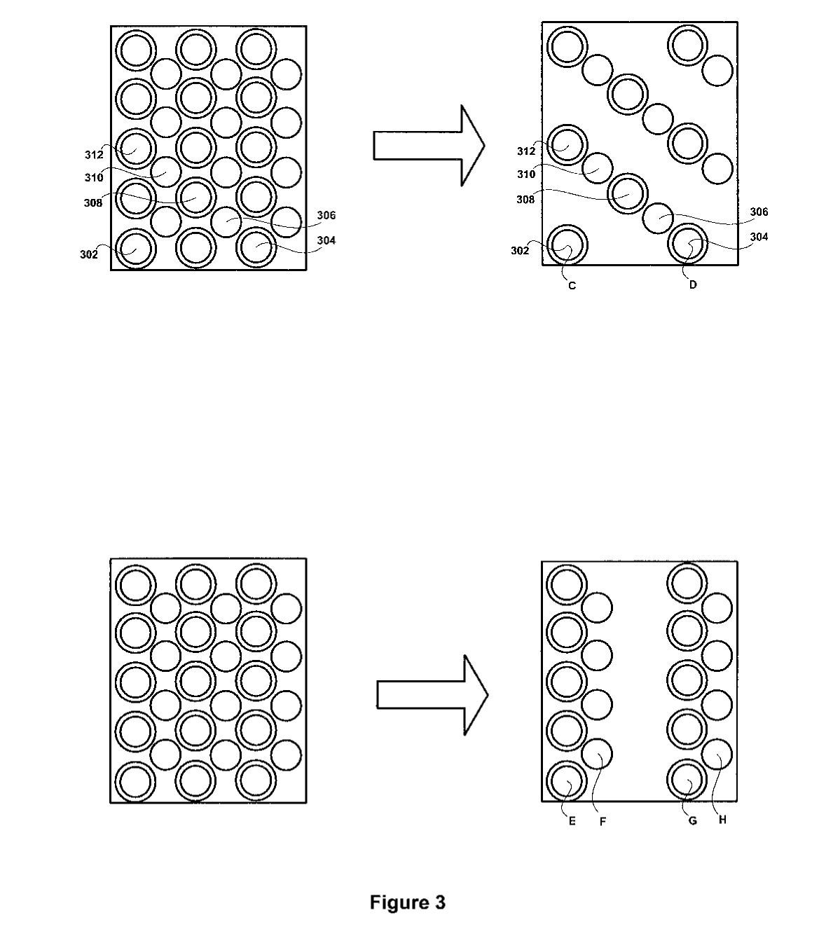

Reference now being made to FIG. 3, a diagram is shown illustrating a layout for ground and power PTHs residing on a package in accordance with a preferred embodiment of the present invention. The elimination of redundant PTHs from the columns or rows modifies the layout of package 102 as illustrated by designs A and B.

In design A, PTHs are removed so as to create several diagonal rows such as diagonal row C defined by PTH 302 and diagonal row D defined by PTHs 304-312. The elimation of redundant PTHs improves the resistance of the package 102 in the x and y axes as shown in the table below.

| | Resistivity ratio to solid plane | | |
|---|---|---|---|
| | Current 102 | Design A | Improvement |
| X | 6.35 | 2.06 | X 3.08 |
| Y | 6.35 | 2.06 | X 3.08 |

Alternatively, as illustrated by design B, the PTHs residing in certain columns are removed such that power PTH columns E, G, and ground PTH columns F and H are remaining. The layout of design B improves the resistance of the package in the x and y axes as illustrated in the table below.

| | Resistivity ratio to solid plane | | |
|---|---|---|---|
| | Current 102 | Design B | Improvement |
| X | 6.35 | 3.68 | X 1.73 |
| Y | 6.35 | 1.66 | X 3.83 |

If there is anisotropy in the power delivery of the package then design B is preferred to design A.

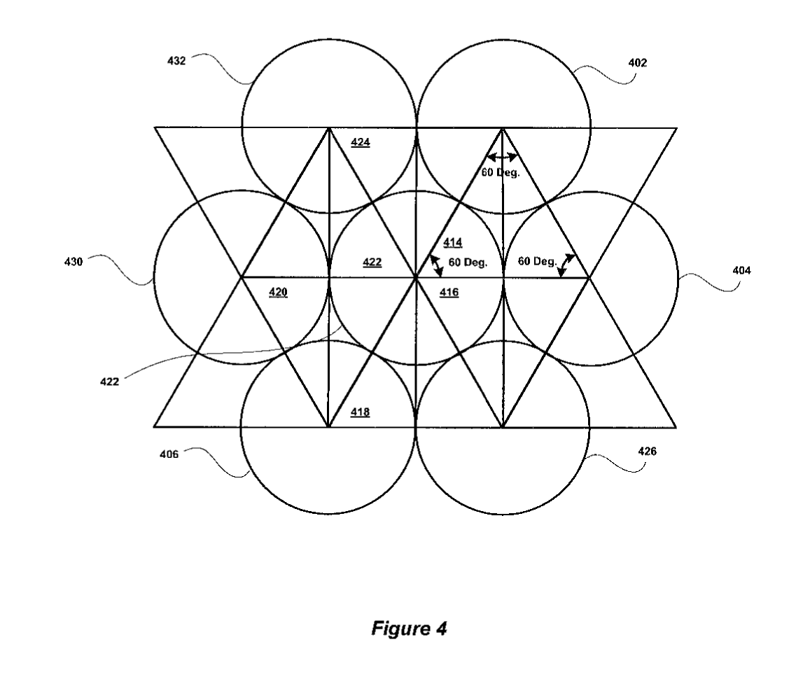

In an alternative preferred embodiment of the present invention, the PTHs are placed in a manner that results in more desirable levels of resistance for the ground plane. In contrast to the square base used in FIG. 1, the alternative preferred embodiment uses an equilateral triangle for the layout of the PTHs. More specifically, the layout results in having the centers of any three PTHs resting on a separate apex of the same equilateral triangle as explained in connection with FIG. 4.

Reference now being made to FIG. 4, a diagram is shown illustrating the placement of PTHs at the apex of an equilateral triangle according to an alternate preferred embodiment of the present invention. As shown, the grid illustrates several different equilateral triangles 414, 416, 418, 420, 422, and 424. Sides 408, 410, and 412 form triangle 414. The centers of PTHs 402, 404, and 406 each rest on a separate apex of equilateral triangle 414. The centers of PTHs 426, 404 and 406 each rest on a separate apex of equilateral triangle 416. The centers of PTHs 428, 406, and 430 each rest on a separate apex of equilateral triangle 420. Likewise, the centers of PTHs 428, 426, and 404 rest on a separate apex of equilateral triangle 418.

In the alternate preferred embodiment, the angles of the triangle 414 are each 60 degrees. It should be noted, however, that the alternate preferred embodiment is not limited to any particular angle for the equilateral triangle so long as each of the apexes of the triangle have the center of a PTH located thereon.

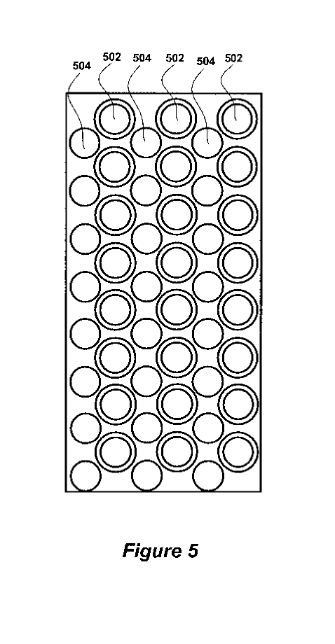

Reference now being made to FIG. 5, a diagram is shown illustrating the placement of PTHs using equilateral triangles as explained in connection with FIG. 4. In this column type layout, power PTH columns 502 and ground PTH columns 504 form the apexes equilateral triangles as previously explained in connection with FIG. 4.

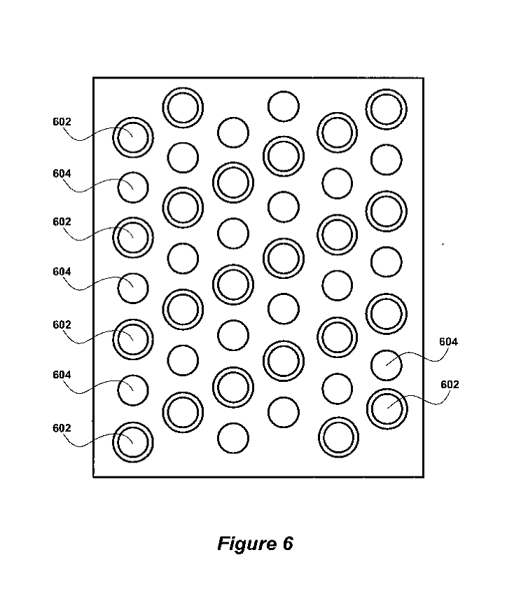

Reference now being made to FIG. 6, a diagram is shown illustrating the placement of PTHs using equilateral triangles as explained in connection with FIG. 4. In this layout, the power PTHs 604 and ground PTHs 602 are placed to rest on the apex of an equilateral triangle as explained in connection with FIG. 4 while residing in a diagonal direction. The diagonal direction can be either increasing (as shown) or decreasing in the y coordinate direction with each successive power or ground PTH proceeding along the x axis.

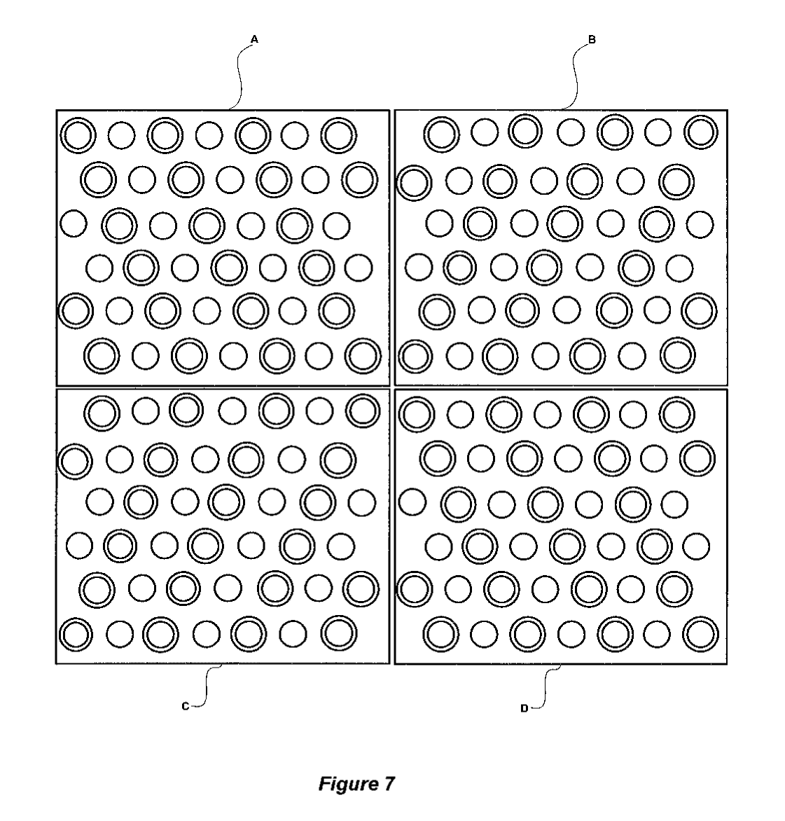

Reference now being made to FIG. 7, a diagram is shown illustrating the placement of PTHs using equilateral triangles as explained in connection with FIG. 4. In this layout, the package 102 has been split into four coordinates A, B, C, and D. Coordinates A and B implement the layout of FIG. 6 in a diagonal direction where the y coordinate of each successive PTH placement increases with an increase in the x axis direction. Coordinates C and D implement the layout of FIG. 6 in a diagonal direction where the y coordinate of each successive PTH placement decreased with each increase in the x-axis direction.

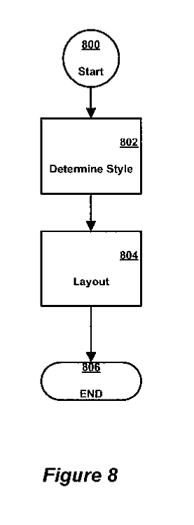

Reference now being made to FIG. 8, a flow chart is shown illustrating the method for placing PTHs on an apex of an equilateral triangle as shown in FIGS. 4-7 according to an alternative preferred embodiment of the present invention. The method begins by selecting a particular style or pattern (e.g. FIG. 7) (Steps 800-802). The method proceeds by placing the PTHs in accordance with the selected style while maintaining the centers of the PTHs on an apex of an equilateral triangle as explained in connection with FIG. 4 (Steps 804-806).

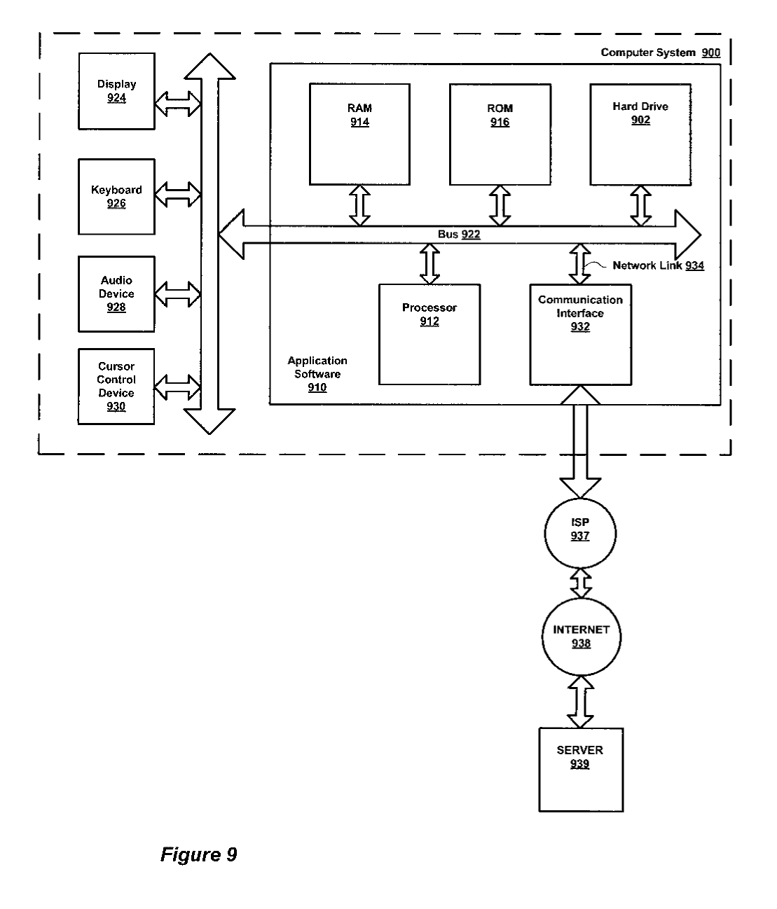

Reference now being made to FIG. 9, a block diagram is shown illustrating a computer system 900 that can perform the hierarchical organization method explained in connection with FIGS. 5-8 above. Computer System 900 includes various components each of which are explained in greater detail below.

Bus 922 represents any type of device capable of providing communication of information within Computer System 900 (e.g., System bus, PCI bus, cross-bar switch, etc.)

Processor 912 can be a general-purpose processor (e.g., the PowerPC™ manufactured by IBM or the Pentium™ manufactured by Intel) that, during normal operation, processes data under the control of an operating system and application software 910 stored in a dynamic storage device such as Random Access Memory (RAM) 914 and a static storage device such as Read Only Memory (ROM) 916. The operating system preferably provides a graphical user interface (GUI) to the user.

The present invention, including the alternative preferred embodiments, can be provided as a computer program product, included on a machine-readable medium having stored on it machine executable instructions used to program computer system 900 to perform a process according to the teachings of the present invention.

The term “machine-readable medium” as used in the specification includes any medium that participates in providing instructions to processor 912 or other components of computer system 900 for execution. Such a medium can take many forms including, but not limited to, non-volatile media, and transmission media. Common forms of non-volatile media include, for example, a floppy disk, a flexible disk, a hard disk, magnetic tape, or any other magnetic medium, a Compact Disk ROM (CD-ROM), a Digital Video Disk-ROM (DVD-ROM) or any other optical medium whether static or rewriteable (e.g., CDRW and DVD RW), punch cards or any other physical medium with patterns of holes, a programmable ROM (PROM), an erasable PROM (EPROM), electrically EPROM (EEPROM), a flash memory, any other memory chip or cartridge, or any other medium from which computer system 900 can read and which is suitable for storing instructions. In the preferred embodiment, an example of a non-volatile medium is the Hard Drive 902.

Volatile media includes dynamic memory such as RAM 914. Transmission media includes coaxial cables, copper wire or fiber optics, including the wires that comprise the bus 922. Transmission media can also take the form of acoustic or light waves, such as those generated during radio wave or infrared data communications.

Moreover, the present invention can be downloaded as a computer program product where the program instructions can be transferred from a remote computer such as server 939 to requesting computer system 900 by way of data signals embodied in a carrier wave or other propagation medium via network link 934 (e.g., a modem or network connection) to a communications interface 932 coupled to bus 922.

Communications interface 932 provides a two-way data communications coupling to network link 934 that can be connected, for example, to a Local Area Network (LAN), Wide Area Network (WAN), or as shown, directly to an Internet Service Provider (ISP) 937. In particular, network link 934 may provide wired and/or wireless network communications to one or more networks.

ISP 937 in turn provides data communication services through the Internet 938 or other network. Internet 938 may refer to the worldwide collection of networks and gateways that use a particular protocol, such as Transmission Control Protocol (TCP) and Internet Protocol (IP), to communicate with one another. ISP 937 and Internet 938 both use electrical, electromagnetic, or optical signals that carry digital or analog data streams. The signals through the various networks and the signals on network link 934 and through communication interface 932, which carry the digital or analog data to and from computer system 900, are exemplary forms of carrier waves transporting the information.

In addition, multiple peripheral components can be added to computer system 900. For example, audio device 928 is attached to bus 922 for controlling audio output. A display 924 is also attached to bus 922 for providing visual, tactile or other graphical representation formats. Display 924 can include both non-transparent surfaces, such as monitors, and transparent surfaces, such as headset sunglasses or vehicle windshield displays.

A keyboard 926 and cursor control device 930, such as mouse, trackball, or cursor direction keys, are coupled to bus 922 as interfaces for user inputs to computer system 900.

The execution of application software 910 on computer system 900 according to a preferred embodiment of the present invention implements the layouts described in FIGS. 3 to 7 and the method described by the flow chart of FIG. 8.

It is thus believed that the operation and construction of the present invention will be apparent from the foregoing description. While the method, system, and computer program product shown and described has been characterized as being preferred, it will be readily apparent that various changes and/or modifications could be made without departing from the spirit and scope of the present invention as defined in the following claims.

What is claimed is:

1. A method for creating a semiconductor package with plated place through holes, the method comprising the steps of:
placing a first plated through hole on a first apex of a first equilateral triangle;
placing a second plated through hole on a second apex of the first equilateral triangle; and
placing a third plated through hole on a third apex of the first equilateral triangle.

2. The method of claim 1 wherein each of the centers of the first, second and third plated through holes reside on the first, second and third apexes, respectively.

3. The method of claim 2 further comprising the steps of:
placing a fourth plated through hole on a first apex of a second equilateral triangle;
placing the second plated through hole on a second apex of the second equilateral triangle; and
placing the third plated through hole on a third apex of the second equilateral triangle.

4. The method of claim 3 wherein the first plated through hole and fourth plated through hole are for power and the second and third plated through holes are for ground.

5. The method of claim 4 wherein the first and fourth plated through holes reside in separate columns from one another, and the second and third plated through holes reside in between the first and fourth plated through holes in a column together.

6. The method of claim 4 wherein the first and fourth plated through holes reside in separate rows from one another where the rows reside in a diagonal direction, and the second and third plated through holes reside in the same row in between the first and fourth plated through holes in a diagonal direction.

7. An apparatus for creating a semiconductor package with plated through holes, the apparatus comprising:
means for placing a first plated through hole on a first apex of a first equilateral triangle;
means for placing a second plated through hole on a second apex of the first equilateral triangle; and
means for placing a third plated through hole on a third apex of the first equilateral triangle.

8. The apparatus of claim 7 wherein each of the centers of the first, second and third plated through holes reside on the first, second and third apexes, respectively.

9. The apparatus of claim 8 further comprising:
means for placing a fourth plated through hole on a first apex of a second equilateral triangle;
means for placing the second plated through hole on a second apex of the second equilateral triangle; and
means for placing the third plated through hole on a third apex of the second equilateral triangle.

10. The apparatus of claim 9 wherein the first plated through hole and fourth plated through hole are for power and the second and third plated through holes are for ground.

11. The apparatus of claim 10 wherein the first and fourth plated through holes reside in separate columns from one another, and the second and third plated through holes reside in between the first and fourth plated through holes in a column together.

12. The apparatus of claim 11 wherein the first and fourth plated through holes reside in separate rows from one another where the rows reside in a diagonal direction, and the second and third plated through holes reside in the same row in between the first and fourth plated through holes in a diagonal direction.

13. A computer program product comprising a computer usable medium having computer usable program code for creating a semiconductor package with plated through holes, the computer program product comprising:
computer usable program code for placing a first plated through hole on a first apex of a first equilateral triangle;
computer usable program code for placing a second plated through hole on a second apex of the first equilateral triangle; and
computer usable program code for placing a third plated through hole on a third apex of the first equilateral triangle.

14. The computer program product of claim 13 wherein each of the centers of the first, second and third plated through holes reside on the first, second and third apexes, respectively.

15. The computer program product of claim 14 further comprising:
computer usable program code for placing a fourth plated through hole on a first apex of a second equilateral triangle;
computer usable program code for placing the second plated through hole on a second apex of the second equilateral triangle; and
computer usable program code for placing the third plated through hole on a third apex of the second equilateral triangle.

16. The computer program product of claim 15 wherein the first plated through hole and fourth plated through hole are for power and the second and third plated through holes are for ground.

17. The computer program product of claim 16 wherein the first and fourth plated through holes reside in separate columns from one another, and the second and third plated through holes reside in between the first and fourth plated through holes in a column together.

18. The computer program product of claim 17 wherein the first and fourth plated through holes reside in separate rows from one another where the rows reside in a diagonal direction, and the second and third plated through holes reside in the same row in between the first and fourth plated through holes in a diagonal direction.
